(19) United States
(12) Patent Application Publication
(10) Pub. No.: US 2026/0330725 A1
(43) Pub. Date: Oct. 22, 2026

(54) IMAGE PROCESSING METHOD AND APPARATUS, ELECTRONIC DEVICE, STORAGE MEDIUM, AND PROGRAM PRODUCT

(71) Applicant: Bytedance Technology Ltd., Grand Cayman (KY)

(72) Inventor: Linsen GAO, Beijing (CN)

(21) Appl. No.: 19/651,290

(22) Filed: Apr. 17, 2026

(30) Foreign Application Priority Data
Apr. 18, 2025 (CN) 202510498779.2

(51) Int. Cl. G06T 11/60; G06T 7/13

(52) U.S. Cl. CPC G06T 11/60; G06T 7/13; G06T 2207/20021; G06T 2207/20221

(57) ABSTRACT

Embodiments of the present disclosure provide an image processing method and apparatus, an electronic device, a storage medium, and a program product. The method includes: determining a first image in response to an image rendering request, wherein the first image includes a single image and/or a plurality of image frames in sequence frame data; and acquiring grid data corresponding to the first image and rendering the first image according to the grid data, wherein the grid data is used for indicating a target image region to be rendered in the first image.

### CROSS-REFERENCE TO RELATED APPLICATION(S)

This application claims priority to Chinese Application No. 202510498779.2 filed Apr. 18, 2025, the disclosure of which is incorporated herein by reference in its entirety.

### TECHNICAL FIELD

Embodiments of the present disclosure relate to the field of computer processing technologies and, in particular, to an image processing method and apparatus, an electronic device, a storage medium, and a program product.

### BACKGROUND

With the development of image processing technology, image rendering has become a very important part in the field of image processing. Through rendering technology, the image can have a better visual experience effect. Therefore, rendering technology has been widely used in recent years.

In the related art, rendering an image usually means rendering and coloring all pixel points of the image to be rendered, that is, acquiring pixel information of all the pixel points, and rendering the image to be rendered based on the acquired pixel information. However, such an image rendering approach needs to process all the pixel points in the image, which may consume a large amount of computing resources, lead to a decline in device performance, and make the image rendering efficiency low.

### SUMMARY

The present disclosure provides an image processing method and apparatus, an electronic device, a storage medium, and a program product.

In a first aspect, an embodiment of the present disclosure provides an image processing method, including:

determining a first image in response to an image rendering request, wherein the first image includes a single image and/or a plurality of image frames in the sequence frame data; and

acquiring grid data corresponding to the first image and rendering the first image according to the grid data, wherein the grid data is used for indicating a target image region to be rendered in the first image.

In a second aspect, an embodiment of the present disclosure further provides an image processing apparatus, including:

an image determination module, configured to determine a first image in response to an image rendering request, wherein the first image includes a single image and/or a plurality of image frames in the sequence frame data; and

an image rendering module, configured to acquire grid data corresponding to the first image and render the first image according to the grid data, wherein the grid data is used for indicating a target image region to be rendered in the first image.

In a third aspect, an embodiment of the present disclosure further provides an electronic device, including:

one or more processors; and

a storage, configured to store one or more programs,

wherein, the one or more programs, when are executed by the one or more processors, cause the one or more processors implement the image processing method according to any one of the embodiments of the present disclosure.

In a fourth aspect, an embodiment of the present disclosure further provides a storage medium including computer-executable instructions, and when the computer-executable instructions are executed by a computer processor, the image processing method according to any one of the embodiments of the present disclosure is performed.

In a fifth aspect, an embodiment of the present disclosure further provides a computer program product, including a computer program, and when the computer program is executed by a processor, the image processing method according to any one of the embodiments of the present disclosure is implemented.

### BRIEF DESCRIPTION OF THE DRAWINGS

The above-mentioned and other features, advantages, and aspects of the embodiments of the present disclosure will become more apparent in combination with the drawings and with reference to the following specific embodiments. Throughout the drawings, the same or similar reference numbers refer to the same or similar elements. It should be understood that the drawings are schematic and that parts and elements are not necessarily drawn to scale.

FIG. 1 is a schematic flowchart of an image processing method according to an embodiment of the present disclosure;

FIG. 2 is a schematic diagram showing an image effect of a first image according to an embodiment of the present disclosure;

FIG. 3 is a schematic flowchart of another image processing method according to an embodiment of the present disclosure;

FIG. 4 is a schematic diagram showing an effect of a process of determining a second sub-region according to an embodiment of the present disclosure;

FIG. 5 is a schematic diagram of a case of a plurality of first sub-regions having a common edge according to an embodiment of the present disclosure;

FIG. 6 is a schematic diagram of a merge operation according to an embodiment of the present disclosure;

FIG. 7 is a schematic diagram of another merge operation according to an embodiment of the present disclosure;

FIG. 8 is a flowchart of an image processing method according to an embodiment of the present disclosure;

FIG. 9 is a schematic structural diagram of an image processing apparatus according to an embodiment of the present disclosure; and

FIG. 10 is a schematic structural diagram of an electronic device for implementing an embodiment of the present disclosure.

### DETAILED DESCRIPTION OF EMBODIMENTS

Hereinafter, embodiments of the present disclosure will be described in more detail with reference to the drawings. Although some embodiments of the present disclosure are shown in the drawings, it should be understood that the present disclosure may be implemented in various forms and should not be construed as limited to the embodiments set forth herein. Instead, these embodiments are provided for a more thorough and complete understanding of the present disclosure. It should be understood that the drawings and embodiments of the present disclosure are only for illustrative purposes, and are not intended to limit the protection scope of the present disclosure.

It should be understood that steps described in method implementations of the present disclosure may be executed in different orders and/or in parallel. In addition, the method implementations may include additional steps and/or omit the execution of the illustrated steps. The scope of the present disclosure is not limited in this regard.

The term “include/comprise” and its variants used herein are open-ended inclusions, that is, “include/comprise but not limited to”. The term “based on” is “at least partially based on”. The term “an embodiment” means “at least one embodiment”. The term “another embodiment” means “at least one other embodiment”. The term “some embodiments” means “at least some embodiments”. Related definitions of other terms will be given in the following description.

It should be noted that concepts such as “first” and “second” mentioned in the present disclosure are only used to distinguish different apparatuses, modules, or units, and are not used to limit the order of functions performed by these apparatuses, modules, or units or their interdependence.

It should be noted that modifications of “a” and “a plurality of” mentioned in the present disclosure are schematic rather than restrictive, and those skilled in the art should understand that unless otherwise clearly indicated in the context, they should be understood as “one or more”.

The names of messages or information exchanged between a plurality of apparatuses in the implementations of the present disclosure are only for illustrative purposes, and are not intended to limit the scope of these messages or information.

It may be understood that before using the technical solution disclosed in the embodiments of the present disclosure, the user should be informed of the type, the range of use, the use scenarios, etc., of personal information involved in the present disclosure and the authorization of the user should be obtained in an appropriate manner in accordance with relevant laws and regulations.

For example, in response to receiving an active request from a user, prompt information is sent to the user to clearly inform the user that the requested operation will require access to and use of the user's personal information. As such, the user may independently choose, based on the prompt information, whether to provide the personal information to software or hardware, such as an electronic device, an application, a server, or a storage medium, that performs the operations of the technical solution of the present disclosure.

As an optional but non-limiting implementation, in response to receiving an active request from a user, the manner of sending prompt information to the user, for example, may be in the manner of a pop-up window, and the prompt information may be presented in the pop-up window in text. In addition, the pop-up window may also carry a selection control for the user to select “agree” or “disagree” to provide personal information to the electronic device.

It may be understood that the above process of notifying and acquiring user authorization is only schematic and does not limit the implementations of the present disclosure. Other manners that satisfy relevant laws and regulations may also be applied to the implementations of the present disclosure.

It may be understood that the data involved in the technical solution (including but not limited to the data itself, acquisition or use of the data) should comply with requirements of corresponding laws, regulations, and related provisions.

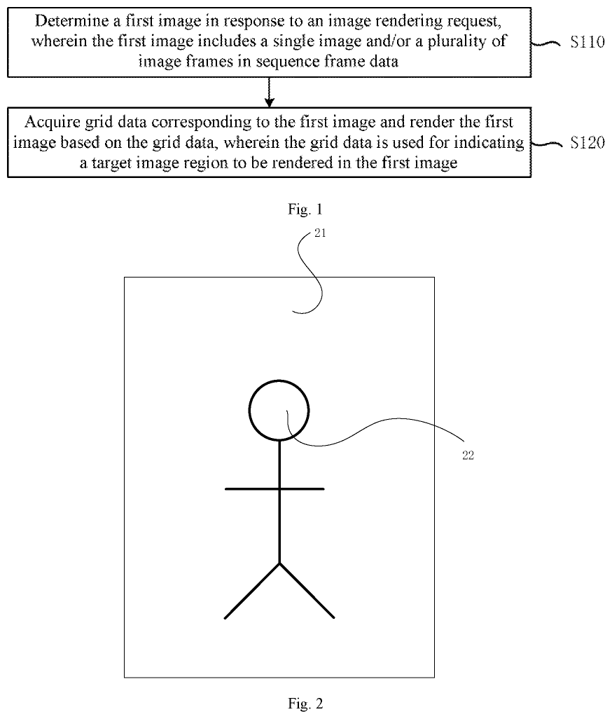

FIG. 1 is a schematic flowchart of an image processing method according to an embodiment of the present disclosure. The embodiment of the present disclosure is applicable to a scenario of performing image rendering on an image to be rendered, and the method may be executed by an image processing apparatus which may be implemented in the form of software and/or hardware, optionally, in an electronic device which may be a mobile terminal, a PC, a server, or the like. As shown in FIG. 1, the method in this embodiment may specifically include the following steps.

S110, a first image is determined in response to an image rendering request, wherein the first image includes a single image and/or a plurality of image frames in the sequence frame data.

The image rendering request may be understood as an instruction for an operation of performing rendering processing on an image, and the instruction may be used for converting image data into a visible image picture. The image rendering request may include a plurality of generation manners. Optionally, in a case where a trigger operation for a preset image rendering control is detected, the image rendering request may be generated; in a case where it is detected that received audio information includes a trigger word associated with image rendering, the image rendering request may be generated; or in a case where it is detected that a received instruction includes an image rendering instruction, the image rendering request may be generated. The first image may be an image used for performing rendering processing. In the embodiment of the present disclosure, the first image may have at least two forms, optionally, including a single image and/or a plurality of image frames in the sequence frame data. The single image is a single independent static image. The sequence frame data may be a series of image frame sets arranged in chronological order, and when the image frames included in the set are played at a specific frame rate, a dynamic visual effect may be formed. Optionally, the sequence frame data includes a video, an animation, an effect, and the like. The image frame is an independent image in the sequence frame data, and the image may be used for representing picture information of the sequence frame data at a specific moment. Exemplarily, the sequence frame data may be video data, and the image frame is a certain video frame in the video data. Optionally, the first image may be a default template image, an image acquired based on a photographing apparatus provided on a terminal device, an image acquired from a target storage space (such as an image library of an application software or a local terminal album) in response to a trigger operation of a user, an image received and uploaded by an external device, or the like. In the embodiment of the present disclosure, in order to reduce resources required for rendering on the basis of ensuring a rendering effect, when rendering the first image, at least part of image regions in the first image may be rendered. In other words, the first image includes a target image region to be rendered, and when rendering the first image, the first image may be rendered according to pixel values of pixel points in the first image and/or rendering parameters included in the image rendering request. Application scenarios of rendering the first image by using the embodiments of the present disclosure may include a plurality of cases, and the following may illustrate several application scenarios separately.

Optionally, the first image may be an image including a foreground image region and a background image region, and the transparency values of pixel points in the background image region are zero. That is, the first image is an image with a transparent background and a foreground object. In this case, the content of a picture visible to the user and rendered on an interface is only the foreground object in the first image. Further, when rendering the first image, rendering the background image region or not rendering the background image region should have no impact on the final rendering effect. Therefore, in order to reduce rendering computing resources and improve image rendering efficiency on the basis of ensuring the image rendering effect of the first image, it is possible to only render the foreground image region including the foreground object, and not render the transparent background, that is, take the foreground image region in the first image as the target image region to be rendered. Exemplarily, FIG. 2 is a schematic diagram showing an image effect of a first image according to an embodiment of the present disclosure. As shown in FIG. 2, a region 21 may be taken as a transparent background region, and a region 22 may be taken as a foreground image region.

Optionally, the first image may be an image including a foreground image region and a background image region. Only rendering the foreground image region in the first image may be taken as a rendering condition, that is, the foreground image region in the first image is taken as the target image region to be rendered. Further, rendering parameters are set according to the rendering condition, and the image rendering request is generated based on the rendering parameters. Further, when the first image is rendered based on the image rendering request, only the target image region in the first image may be rendered.

Optionally, the first image may be an image with any content. Rendering pixel points, in the pixel points in the first image, whose color values of at least one color channel are within a preset color value range may be taken as a rendering condition, that is, an image region, in the first image, that is composed of the pixel points whose color values of at least one color channel are within the preset color value range is taken as the target image region to be rendered. Further, rendering parameters may be set according to the rendering condition, and the image rendering request may be generated based on the rendering parameters. Further, the first image is rendered based on the image rendering request to render the target image region in the first image.

As an optional implementation of the embodiment of the present disclosure, in a case where a trigger operation for a preset image rendering control is detected, the image rendering request may be generated. Further, in response to the image rendering request, an effect showing interface is displayed, and the effect showing interface includes at least one candidate effect. Further, in a case where a selection operation for any effect is detected, a selected candidate effect may be determined according to the selection operation, and an effect animation corresponding to the candidate effect is taken as the sequence frame data. Further, the plurality of image frames in the sequence frame data may be taken as the first image.

S120, grid data corresponding to the first image is acquired and the first image is rendered according to the grid data, wherein the grid data is used for indicating a target image region to be rendered in the first image.

The grid data may be understood as a rendering basis required when the first image is rendered, and the rendering basis may include information about pixel points to be rendered that is required when the first image is rendered. The grid data may be composed of vertex data of a plurality of triangular patches. Optionally, the vertex data includes information such as coordinates, normal, and texture coordinates of a vertex. The grid data is used for indicating the target image region to be rendered in the first image, that is, through the grid data, it may be determined which image regions in the first region need to be rendered. The target image region is an image region in the first image that needs to be rendered. In the embodiment of the present disclosure, the target image region may be an image region in the first image that is composed of pixel points whose transparency values are not zero.

In the embodiment of the present disclosure, the grid data corresponding to the first image may be predetermined, and further, in a case where the first image is determined, the grid data corresponding to the first image may be acquired according to the first image. A determination timing of the grid data may be before the grid data corresponding to the first image is acquired. Before acquiring the grid data corresponding to the first image, there may be at least two cases: before the image rendering request for the first image is received; or after the image rendering request for the first image is received for the first time.

Optionally, before the image rendering request for the first image is received, grid data corresponding to a plurality of candidate images may be determined in advance, and the grid data and the corresponding candidate images may be stored correspondingly. Further, in a case where the image rendering request for the first image is received, in response to the image rendering request, the grid data corresponding to the first image is retrieved from a plurality of pieces of grid data stored in advance. Further, the first image is rendered according to the retrieved grid data. It should be noted that in this case, the process of determining the grid data may be completed when the terminal device is in an offline state. The advantage of such setting is that by determining the grid data in advance in the offline state, the rendering calculation amount during running may be minimized, the rendering efficiency may be greatly improved, and the stability of terminal rendering may be improved.

Optionally, in a case where the first image is rendered more than once, after the image rendering request for the first image is received for the first time, the grid data corresponding to the first image may be determined, and the determined grid data may be stored correspondingly with the first image. Further, the first image may be rendered according to the grid data. After that, in a case where the image rendering request for the first image is received not for the first time, stored grid data corresponding to the first image may be retrieved based on the first image. Further, the first image may be rendered according to the retrieved grid data. It should be noted that in this case, the process of determining the grid data should be completed when the terminal device is in an online state.

In the embodiment of the present disclosure, before acquiring the grid data corresponding to the first image, the grid data corresponding to the first image may be determined first. Further, the grid data corresponding to the first image may be acquired, and the first image may be rendered according to the grid data.

It should be noted that in a case where the first image includes a single image, grid data corresponding to the single image may be determined. Further, the determined grid data corresponding to the single image is acquired according to the single image, and the single image is rendered based on the grid data.

In the case where the first image includes a plurality of image frames in the sequence frame data, the corresponding grid data may include one or more pieces. In this case, in order to improve the acquisition efficiency of the grid data, after the grid data corresponding to the plurality of image frames is determined, the grid data corresponding to the plurality of image frames may be stored correspondingly with the sequence frame data. Further, when the grid data corresponding to the sequence frame data is acquired, the grid data corresponding to the sequence frame data may be retrieved directly from pre-stored grid data according to the sequence frame data, and the retrieved grid data includes the grid data corresponding to the plurality of image frames. For example, the grid data corresponding to the plurality of image frames may be stored correspondingly with a sequence frame identification of the sequence frame data. Further, in a case where the sequence frame data is determined, the sequence frame identification corresponding to the determined sequence frame data may be acquired, and the grid data corresponding to the sequence frame identification may be retrieved from the pre-stored grid data according to the sequence frame identification.

It should also be noted that in the case where the first image includes a plurality of image frames in the sequence frame data, when the grid data corresponding to the sequence frame data is determined, there may be a plurality of cases: determining grid data corresponding to each image frame in the sequence frame data; or dividing the plurality of image frames in the sequence frame data into at least one image frame set, wherein the image frame set includes at least one image frame; and further, determining grid data corresponding to the image frame set for the at least one image frame set, so that at least one piece of grid data may be obtained, and the obtained at least one piece of grid data is taken as the grid data corresponding to the sequence frame data.

Optionally, in a case where the first image includes a plurality of images in the sequence frame data, acquiring the grid data corresponding to the first image includes: determining an image frame to be rendered in the sequence frame data and determining grid data corresponding to the image frame according to metadata corresponding to the sequence frame data.

The image frame to be rendered may be an image frame in the sequence frame data that needs to be rendered. In the case where the first image includes a plurality of image frames in the sequence frame data, there may be a case where part of the plurality of image frames are rendered, and certainly, there may also be a case where all of the plurality of image frames are rendered. In this case, the image frames in the plurality of image frames that need to be rendered may be taken as image frames to be rendered. The image frames to be rendered may be at least part of the image frames in the sequence frame data. The metadata is used for indicating a correspondence between the grid data and the image frames. The metadata may be understood as information capable of describing a mapping relationship between the image frames and the corresponding grid data. The metadata may be constructed in a plurality of manners, optionally, through identification correspondence information, an index table form, and/or database association, and the like. In addition to the information capable of indicating the correspondence between the grid data and the image frames, the metadata may further include information used for describing sequence frame attributes of the sequence frame data, optionally, including at least one of frame resolution, frame rate, sequence frame timestamp, and frame number.

As an optional implementation of the embodiment of the present disclosure, for a plurality of image frames in the sequence frame data, grid data corresponding to each image frame may be determined in advance, a frame identification corresponding to the image frame and a grid identification corresponding to the grid data may be determined, a correspondence between the frame identification and the grid identification may be established, metadata may be determined based on the correspondence, and the metadata is taken as metadata corresponding to the sequence frame data. Further, in a case where a first image is determined based on an image rendering request and the first image includes the plurality of image frames in the sequence frame data, an image frame that needs to be rendered this time in the sequence frame data may be determined, and the determined image frame is taken as an image frame to be rendered. Further, the metadata corresponding to the sequence frame data is acquired, and a frame identification corresponding to the image frame to be rendered is acquired. Then, the metadata may be searched according to the frame identification to determine a grid identification of grid data corresponding to the image frame. Further, the corresponding grid data may be retrieved from a database storing the grid data according to the grid identification, and the retrieved grid data is taken as the grid data corresponding to the image frame to be rendered. Then, grid data corresponding to the first image may be acquired. Further, the first image may be rendered according to the grid data.

In the embodiment of the present disclosure, the grid data is combined with the vertex data of a plurality of triangular patches. Further, when the first image is rendered according to the grid data, the target image region to be rendered in the first image may be rendered according to the vertex data included in the grid data.

Optionally, rendering the first image according to the grid data includes: for a pixel point included in the grid data, determining a sampling position of the pixel point in the first image and a display position of the pixel point in a display region; and sampling a color value in the first image according to the sampling position and rendering the pixel point to the display position corresponding to the pixel point according to the color value. In this manner, an image corresponding to grid data is rendered based on the grid data capable of indicating an image region to be rendered, thereby achieving the effect of precisely rendering the image to be rendered in regions, reducing the rendering calculation amount, and improving the rendering efficiency.

The pixel point may be a pixel point in the target image region, that is, a pixel point that needs to undergo rendering processing. The sampling position may refer to a specific position for sampling to acquire the color value of the pixel point in the first image, that is, a pixel position of the pixel point in the first image. Optionally, the sampling position may be pixel coordinates of the pixel point in the first image. The display region may be a region where the first image is finally rendered and displayed. The pixel point will be presented in the display region after rendering. Optionally, the display region may be a display interface of a terminal device or a specific region on other display devices. The display position may be a position where the pixel point is finally presented in the display region. Optionally, the display position may be display coordinates of the pixel point in the display region. The color value may represent color information of the pixel point, and is usually represented by three components of red (R), green (G), and blue (B) or parameters of other color spaces.

In a specific implementation, in a case where the grid data corresponding to the first image is acquired, the grid data is parsed to determine the pixel point included in the grid data and pixel data corresponding to the pixel point. Further, for the pixel point included in the grid data, the sampling position of the pixel point in the first image and the display position of the pixel point in the display region may be determined according to the pixel data of the pixel point and a coordinate mapping relationship between the first image and the display region. Further, a color sampling operation is performed in the first image according to the determined sampling position to acquire the color value of the pixel point. Further, the pixel point may be rendered to the display position corresponding to the pixel point in the display region according to the color value, so that the pixel point displays a corresponding color at the display position. Further, based on the above steps, all the pixel points included in the grid data are rendered to the corresponding display positions in the display region, thus completing rendering of the first image.

It should be noted that, in the embodiment of the present disclosure, the first image is rendered according to the grid data, and the grid data is used for indicating the target image region to be rendered in the first image. Further, when rendering is performed based on the above process, only the target image region is rendered, and other image regions other than the target image region in the first image may not be rendered. Further, the image finally rendered and displayed may be an image matching the target image region.

In order to facilitate understanding of the technical solution of the embodiments of the present disclosure, examples will be described in conjunction with a live streaming scenario. In an application scenario, the first image may include a preset animation sequence frame and/or sticker displayed in a live video stream. These animation sequence frames and/or stickers may be triggered or set by a live streaming end or may be triggered by a user end. Usually, these animation sequence frames and/or stickers are used for displaying a preset virtual object. In practical applications, in order to make the virtual object more vivid, its outer contour or shape is not all regular shapes. In order to facilitate efficient rendering of the virtual object by an image processor, pixel points around the virtual object are usually filled to expand the virtual object into a rectangular image that may be quickly processed by the image processor. In related art, when the virtual object is rendered, each pixel point in the first image needs to be rendered, and then the transparency of the filled pixel point is set to be completely transparent. However, such a solution still needs to render all the pixel points in the first image, or the pixel points that need to be filled, but these pixel points are actually invisible to the user, which causes a waste of rendering resources to a certain extent. Moreover, the rendering efficiency is also affected, and in a scenario with a high real-time requirement (such as, live streaming), the live streaming or viewing experience of the user may probably be affected.

In the embodiment of the present disclosure, since the preset animation sequence frame and/or sticker displayed in the live video stream are usually images or image combinations with preset and known content, the grid data corresponding to the preset animation sequence frame and/or sticker may be determined first in the offline state, and then, when a rendering request for the preset animation sequence frame and/or sticker is received, the preset animation sequence frame and/or sticker may be quickly rendered according to the grid data. In this manner, not only the display effect of the virtual object may be improved, so that the displayed virtual object fits better with a live streaming picture and unnecessary occlusion of the live streaming picture is reduced, but also the online rendering efficiency of these animation sequence frames and/or stickers may be significantly improved, and the real-time performance of display is enhanced. In particular, the grid data may be reused in a plurality of scenarios where animation sequence frames and/or stickers need to be displayed, thereby greatly saving resources consumed by rendering and further improving the rendering efficiency of animation sequence frames and/or stickers.

In the technical solution of the embodiments of the present disclosure, a first image is determined in response to an image rendering request to provide a data basis for subsequent rendering operations. Since the first image includes a single image and/or a plurality of image frames in the sequence frame data, the single image and/or the plurality of image frames in the sequence frame data are supported as the first image to be rendered, so that the technical solution may be applied to various different scenarios to meet diverse requirements for image rendering. Further, grid data corresponding to the first image is acquired, and the first image is rendered according to the grid data. Since the grid data is used for indicating a target image region to be rendered in the first image, the problem in the related art that rendering computing resources are greatly consumed, resulting in a decline in device performance and low rendering efficiency, is solved. An image corresponding to grid data is rendered based on the grid data capable of indicating an image region to be rendered, thereby achieving the effect of precisely rendering the image to be rendered in regions, reducing the rendering calculation amount, improving the rendering efficiency, and achieving the effect of saving computing resources to the maximum extent on the premise of ensuring the rendering quality of the image region to be rendered in the image, so that a balance between rendering quality and rendering efficiency is achieved.

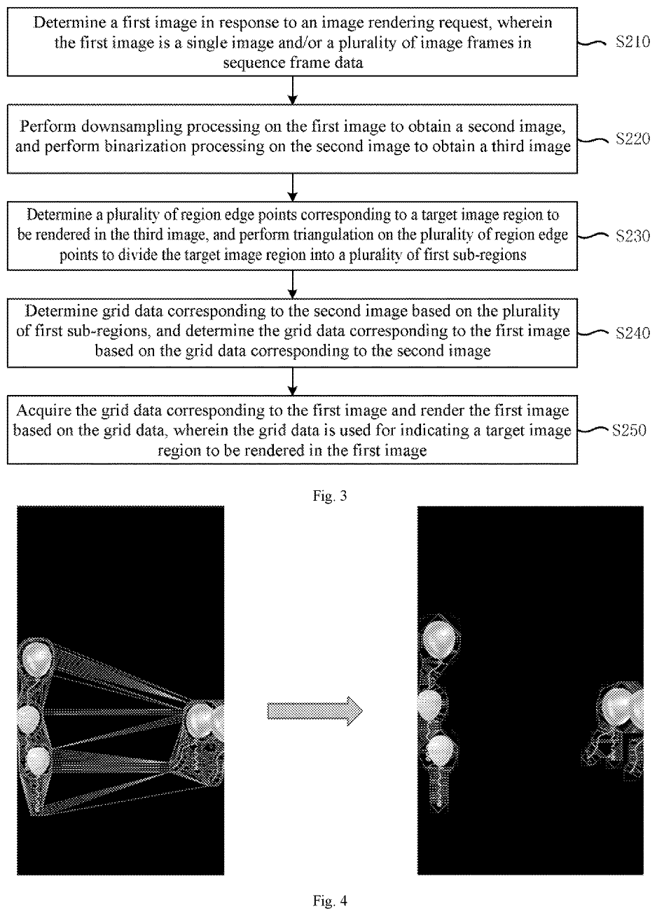

FIG. 3 is a schematic flowchart of another image processing method according to an embodiment of the present disclosure. Based on the technical scheme of the above embodiment, in the technical scheme of this embodiment, before the grid data corresponding to the first image is acquired, the grid data corresponding to the first image may be determined first. Optionally, before acquiring the grid data corresponding to the first image, the method further includes: performing downsampling processing on the first image to obtain a second image, and performing binarization processing on the second image to obtain a third image; determining a plurality of region edge points corresponding to the target image region to be rendered in the third image, and performing triangulation on the plurality of region edge points to divide the target image region into a plurality of first sub-regions; and determining grid data corresponding to the second image according to the plurality of first sub-regions, and determining the grid data corresponding to the first image according to the grid data corresponding to the second image. For a specific implementation, reference may be made to the description of this embodiment. The technical features the same as or similar to those in the above embodiment are not repeated here. As shown in FIG. 3, the method in this embodiment may specifically include the following steps.

S210, a first image is determined in response to an image rendering request, wherein the first image includes a single image and/or a plurality of image frames in the sequence frame data.

S220, downsampling processing is performed on the first image to obtain a second image, and binarization processing is performed on the second image to obtain a third image.

The downsampling processing is an operation of performing downsampling on an image, and the operation reduces the resolution of the image by reducing the number of pixels in the image. Pixel points of the first image are sampled according to a certain sampling rate to obtain an image with a smaller size. The downsampling processing may reduce the amount of data, improve the efficiency of subsequent processing, and remove some high-frequency noise in the image to some extent. The downsampling processing may be performed by using a plurality of algorithms, optionally, including an average algorithm, a max pooling algorithm, a pyramid downsampling algorithm, and the like. The second image is an image obtained after the sampling processing is performed on the first image. The resolution of the second image is lower than that of the first image, and the number of pixel points of the second image is less than that of the first image. The binarization processing may be a processing manner of converting an image into an image with only two colors (that is, including only two pixel values). The third image is an image obtained after the binarization processing is performed on the second image, and the third image is a binary image, that is, the third image includes only two pixel values. Exemplarily, the third image includes only two pixel values of 0 and 1, and is a black-and-white binary image.

In the embodiment of the present disclosure, one or more second images may be obtained. In other words, the downsampling processing performed on the first image may include at least two processing manners, which are: performing downsampling processing on the first image by using a first preset downsampling parameter to obtain one second image; and/or performing downsampling processing on the first image by using a plurality of second preset downsampling parameters to obtain a plurality of second images.

It may be understood that after the downsampling processing is performed on the first image, the number of pixel points of the obtained second image is less than that of the first image, and although the effect of reducing the amount of data is achieved, the quality of the rendering effect of a display image obtained by rendering based on the second image may be relatively low. In view of this, in the embodiment of the present disclosure, the downsampling processing may be performed on the first image by using a plurality of second preset downsampling parameters to obtain a plurality of second images. Further, grid data corresponding to each second image may be determined separately, and the grid data corresponding to the first image is determined from the grid data corresponding to the plurality of second images according to the grid data. Therefore, the technical effect of improving the quality of the rendered image and the display effect of the rendered image on the basis of reducing computing resources is achieved.

In the embodiment of the present disclosure, the first image may be an image including a transparent background and a foreground object, or may be any image in which the transparency values of pixel points in the image are all not zero. The binarization processing performed on the second image may be to determine the target image region to be rendered in the first image based on the third image. Further, when the binarization processing is performed on the second image, at least two processing manners may be included, which are: according to the transparency values of the pixel points; and/or according to color values of color channels of the pixel points.

Optionally, performing binarization processing on the second image includes: performing binarization processing on the second image according to the transparency values of pixel points in the second image.

The transparency value may be used for representing a transparent degree of the pixel point. The transparency value is usually represented by a numerical value, and a value range is generally from 0 to 1 or 0% to 100%. 0 (or 0%) represents that the pixel point is completely transparent, that is, the pixel point is invisible; 1 (or 100%) represents that the pixel point is completely non-transparent, that is, the pixel point is completely displayed; and a numerical value between 0 and 1 represents semi-transparent states of different degrees, and the greater the numerical value, the lower the transparency, and the more non-transparent the pixel point.

It may be learned based on the above embodiment that the target image region may be an image region whose transparency value is not zero. Further, when the binarization processing is performed on the second image, the transparency value of each pixel point in the second image may be acquired. Further, pixel points, of these pixel points, whose transparency values are zero may be selected and taken as first pixel points, and pixel values of the first pixel points are adjusted to a first numerical value (for example, 0); and pixel points other than the first pixel points in the second image are taken as second pixel points, and pixel values of the second pixel points are adjusted to a second numerical value (for example, 1). Further, the second image with the adjusted pixel values may be taken as the third image.

Optionally, performing binarization processing on the second image includes: performing binarization processing on the second image according to color values of at least one color channel of pixel points in the second image.

It may be understood that, in the image, a color of the pixel point is usually represented by a plurality of channels, and these channels may be taken as color channels. Common color channels include a red channel, a green channel, and a blue channel. In addition, there are other color channel representation forms, such as a brightness channel in HSV (hue, saturation, and brightness). The color value may be a numerical value used for representing color intensity or content in each color channel. In an RGB image, the color value of each channel is usually an integer between 0 and 255, wherein 0 represents that the intensity of the color of the channel is the lowest, and 255 represents that the intensity of the color of the channel is the highest.

As an optional implementation of the embodiment of the present disclosure, an RGB value range may be preset, and the RGB value range may include a color value range of at least one color channel. Further, for the pixel points in the second image, an RGB value of a pixel point may be acquired, and the RGB value is compared with the preset RGB value range. Further, in a case where the RGB value of the pixel point is not within the RGB value range, the pixel point may be taken as a third pixel point, and a pixel value of the third pixel point is adjusted to a third numerical value (for example, 0); and pixel points other than the third pixel point in the second image are taken as fourth pixel points, and pixel values of the fourth pixel points are adjusted to a fourth numerical value (for example, 1). Further, the second image with the adjusted pixel values may be taken as the third image. Exemplarily, the RGB value range may be an interval composed of RGB values from (150, 150, 150) to (255, 150, 150), and the interval may include a color value range of the red channel from 150 to 255.

The binarization processing performed on the second image based on at least two manners described above has the following advantages: application scenarios of image rendering are enriched, so that the technical scheme may determine the image region to be rendered according to not only the transparency value but also the color value, and the flexibility of the rendering approach is enhanced.

S230, a plurality of region edge points corresponding to the target image region to be rendered in the third image is determined, and triangulation is performed on the plurality of region edge points to divide the target image region into a plurality of first sub-regions.

The region edge points may be pixel points on an edge of the target image region, and these pixel points may define the edge of the target image region and are boundaries between the target image region and other image regions. The triangulation is an operation of connecting a series of discrete points into triangles. Through the triangulation, the plurality of region edge points are connected to form several non-overlapping triangles, thereby dividing the target image region into the plurality of first sub-regions. In this case, the first sub-regions are triangular regions obtained after the triangulation is performed on the plurality of region edge points.

In the embodiment of the present disclosure, the region edge points may be edge pixel points obtained after region edge detection is performed on the target image region in the third image; or in order to expand a region boundary to make a region that may be originally discontinuous or fuzzy become more continuous and prominent, and obtain more complete region edge information, it is also possible to first perform dilation processing on the target image region and perform edge detection on the target image region after the dilation processing to obtain the plurality of region edge points.

Optionally, determining the plurality of region edge points corresponding to the target image region to be rendered in the third image includes: performing dilation processing on the target image region to be rendered in the third image, and acquiring the plurality of region edge points of the dilated target image region.

The dilation processing is an operation of expanding an edge of the target image region outward to increase an area of the target image region. Optionally, common manners of dilation processing include: dilation based on a structural element, dilation based on a distance transform, dilation based on a morphological gradient, dilation based on a connected region, and the like.

In a specific implementation, in a case where the third image is obtained, the target image region in the third image is determined based on the pixel values of the pixel points in the third image. Further, the dilation processing may be performed on the target image region by using a dilation algorithm to obtain the dilated target image region. Further, edge detection may be performed on the dilated target image region by using an edge detection algorithm, and the detected pixel points are taken as the plurality of region edge points corresponding to the target image region.

In the embodiment of the present disclosure, in a case where the plurality of region edge points are obtained, the triangulation may be performed on the plurality of region edge points by using a triangulation algorithm to divide the target image region into the plurality of first sub-regions. Optionally, the triangulation algorithm includes a Delaunay algorithm, an ear clipping algorithm, an exhaustive method, or the like.

Exemplarily, the Delaunay algorithm is used as an example to briefly describe the triangulation process: 1. calculating a bounding box of a first point set composed of the plurality of region edge points, and updating four vertices of the bounding box to the first point set to obtain a second point set; generating two super triangles according to the bounding box to construct an initial triangulation, wherein the initial triangulation may be a Delaunay triangulation; then, inserting vertices in the first point set into the initial triangulation one by one, and adjusting as follows: in the initial triangulation, a union of all triangles whose circumscribed circles contain a first vertex (any vertex in the first point set) constitutes a star-shaped polygon, wherein the star-shaped polygon means that a connection line from any vertex of the polygon to the first vertex is inside the polygon; for the above star-shaped polygon, all triangles inside the star-shaped polygon are deleted to form a “cavity”; and vertices on a boundary of the cavity are connected to the newly added first vertex to obtain new triangles to replace the deleted triangles in the triangulation, at this time, a new Delaunay triangulation containing the first vertex is obtained; and then, when the last vertex is inserted into the triangulation and all edge flipping operations are completed, a Delaunay triangulation of the second point set may be obtained; and further, deleting the four vertices of the bounding box added previously, and removing all triangles connected to the four vertices, then the remaining triangles constitute a Delaunay triangulation of the first point set, that is, the plurality of first sub-regions are obtained.

S240, grid data corresponding to the second image is determined according to the plurality of first sub-regions, and the grid data corresponding to the first image is determined according to the grid data corresponding to the second image.

In the embodiment of the present disclosure, in the case where the plurality of first sub-regions are obtained, the grid data corresponding to the second image may be determined according to the plurality of first sub-regions. Determining the grid data based on the plurality of first sub-regions may be determining, based on the plurality of sub-regions, the image region where the pixel points to be rendered are located. In general, the plurality of first sub-regions determined may include redundant pixel points, that is, pixel points that do not need to be rendered. Further, region pixel point detection may be first performed on the plurality of first sub-regions to eliminate the pixel points that do not need to be rendered from the plurality of sub-regions, thereby achieving the effects of reducing the amount of data and improving the rendering efficiency.

Optionally, determining the grid data corresponding to the second image according to the plurality of first sub-regions includes: determining a second sub-region in the plurality of first sub-regions according to pixel values of pixel points in the first sub-regions and a preset numerical value, and determining the grid data corresponding to the second image according to the second sub-region. In this manner, the effect of optimizing the sub-regions obtained after the triangulation according to the pixel values is achieved, and then, a subsequent case of performing rendering processing on redundant sub-regions is avoided, the amount of data to be processed and the resource space occupied by the grid data are reduced, and the flexibility of the grid data determination manner is improved.

The preset numerical value is used for indicating the pixel points in the target image region. That is, the preset numerical value may be a basis for determining and selecting whether the pixel points belong to the target image region. The preset numerical value may be a color value, a grayscale value, or other numerical values related to the pixel points. Exemplarily, the preset numerical value may be 1, that is, a pixel point whose pixel value is 1 belongs to the target image region, and a pixel point whose pixel value is not 1 does not belong to the target image region.

In a specific implementation, for the plurality of first sub-regions, the pixel values of the pixel points in the first sub-regions may be compared with the preset numerical value. Further, in a case where a pixel value of any pixel point in a first sub-region is the preset numerical value, the first sub-region may be retained; or in a case where pixel values of all the pixel points in a first sub-region are not the preset numerical value, the first sub-region is deleted. Further, the remaining first sub-regions may be taken as the second sub-region.

Exemplarily, FIG. 4 is a schematic diagram showing an effect of a process of determining a second sub-region according to an embodiment of the present disclosure. As shown in the left figure of FIG. 4, a triangular region included in the left figure of FIG. 4 may be taken as a first sub-region. Further, for a plurality of first sub-regions, pixel values of pixel points in the first sub-region are compared with 1, and in a case where the pixel values of all the pixel points in the first sub-region are not 1, the first sub-region is deleted, that is, a first sub-region whose interior is all black in color in the left figure of FIG. 4 is deleted. After region deletion, the remaining first sub-region may be taken as the second sub-region, as shown in the right figure of FIG. 4. Compared with the right figure of FIG. 4, in the right figure of FIG. 4, a triangular region between a left balloon region and a right balloon region is deleted, and the number of triangular regions is reduced. At this time, the triangular region included in the right figure of FIG. 4 may be taken as the second sub-region.

In the embodiment of the present disclosure, after the triangulation, there may be a case where the number of the obtained first sub-regions is relatively large. At this time, the plurality of first sub-regions may be optimized without changing the overall region structure of the target image region to reduce the number of first sub-regions.

Optionally, determining the grid data corresponding to the second image according to the plurality of first sub-regions includes: performing region reconstruction on the plurality of first sub-regions to obtain a plurality of third sub-regions, and determining the grid data corresponding to the second image according to the plurality of third sub-regions. In this manner, the effect of optimizing the sub-regions obtained after the triangulation according to the region shapes is achieved, and then, a subsequent case of performing rendering processing on redundant sub-regions is avoided, the amount of data to be processed and the resource space occupied by the grid data are reduced, and the flexibility of the grid data determination manner is improved.

The shape of the third sub-regions is the same as that of the first sub-regions, and the number of the third sub-regions is less than that of the first sub-regions.

The region reconstruction may be understood as an operation of performing operations such as merging, adjustment, or recombination on the plurality of first sub-regions to change the structure and distribution of the plurality of first sub-regions. Optionally, the region reconstruction includes operations such as region merging and region re-division.

It should be noted that, in a case where the number of the third sub-regions is less than that of the first sub-regions, it may represent that the region reconstruction is to merge the plurality of first sub-regions, and merge at least two first sub-regions into one sub-region. Further, performing region reconstruction on the plurality of first sub-regions may be first determining at least two first sub-regions that may be merged into one sub-region, and then, determining the third sub-regions according to a merge result.

Optionally, performing region reconstruction on the plurality of first sub-regions to obtain the plurality of third sub-regions includes: merging a plurality of first sub-regions having a common edge, and determining the plurality of third sub-regions according to a merge result. In this manner, the effect of merging the sub-regions with the common edge to reduce the number of sub-regions is achieved, the rendering calculation amount is reduced to some extent, and the rendering efficiency is improved.

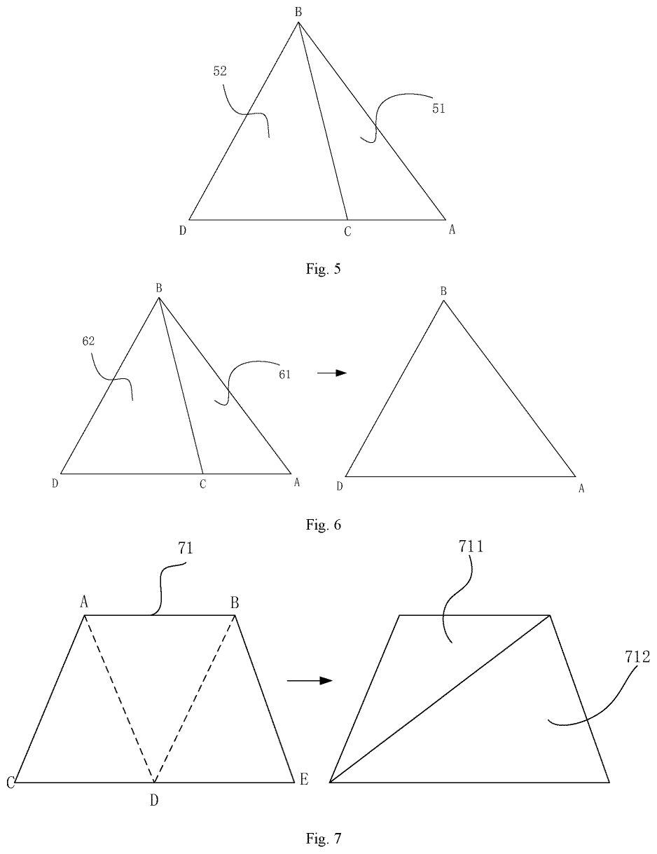

The plurality of first sub-regions having the common edge means that, in these first sub-regions, there are some first sub-regions that share an edge. Exemplarily, FIG. 5 is a schematic diagram of a case of a plurality of first sub-regions having a common edge according to an embodiment of the present disclosure. As shown in FIG. 5, a first sub-region A is a triangular region composed of points A, B, and C, and a first sub-region B is a triangular region composed of points B, C, and D. The first sub-region A and a second sub-region B have a common edge, which is edge BC. At this time, a first sub-region 51 and a first sub-region 52 may be taken as two first sub-regions having a common edge.

In a specific implementation, for the plurality of first sub-regions, the plurality of first sub-regions may be detected to determine the plurality of first sub-regions having the common edge from the plurality of first sub-regions. Further, the plurality of first sub-regions having the common edge may be merged, and a merged sub-region is taken as a third sub-region.

In the embodiment of the present disclosure, when the first sub-regions are merged to determine the third sub-regions, it is necessary to ensure that the shape of the third sub-regions is the same as that of the first sub-regions, and the number of the third sub-regions is less than that of the first sub-regions. In a case where the region merging requirement is met, at least two merge manners may be included, which are: in the merging process, stopping merging when it is impossible to merge into a sub-region with the same shape as the first sub-region; or in a case where the shape of a merged sub-region is different from that of the first sub-region, performing triangulation on the merged sub-region, and the like.

Optionally, merging the plurality of first sub-regions having the common edge, and obtaining the plurality of third sub-regions according to the merge result includes: merging the plurality of first sub-regions having the common edge into sub-regions with the same shape as the first sub-regions to obtain the plurality of third sub-regions.

As an optional implementation of the embodiment of the present disclosure, in a case where the plurality of first sub-regions having the common edge are determined, the plurality of first sub-regions having the common edge may be merged into a sub-region with the same shape as the first sub-regions. Further, in a case where it is impossible to merge into the sub-region with the same shape as the first sub-region, merging is stopped, and a merged sub-region is taken as the third sub-region.

Exemplarily, FIG. 6 is a schematic diagram of a merge operation according to an embodiment of the present disclosure. As shown in the left figure of FIG. 6, a first sub-region 61 and a second sub-region 62 have a common edge BC. Further, the first sub-region 61 and the first sub-region 62 may be merged into a triangle, and a triangular region as shown in the right figure of FIG. 6 may be obtained, and the triangular region may be taken as the third sub-region.

Optionally, merging the plurality of first sub-regions having the common edge, and obtaining the plurality of third sub-regions according to the merge result includes: merging the plurality of first sub-regions having the common edge, and performing triangulation on the merged sub-region to obtain the plurality of third sub-regions.

As another optional implementation of the embodiment of the present disclosure, in the case where the plurality of first sub-regions having the common edge are determined, the plurality of first sub-regions having the common edge may be merged, and the obtained merged sub-region may include a sub-region with the same shape as the first sub-region and/or a sub-region with a different shape from the first sub-region. Furthermore, in order to ensure that the shape of the finally obtained third sub-region is the same as that of the first sub-region, the merged sub-region may be re-triangulated, and a divided sub-region is taken as the third sub-region.

It should be noted that performing triangulation on the merged sub-region may include: performing triangulation on the sub-region with a different shape from the first sub-region; or performing triangulation on all merged sub-regions.

The sub-region merging performed by using at least two manners described above has the following advantages: the processing manners of sub-region merging are enriched, different processing requirements are considered, and the flexibility of the processing manners is improved; moreover, both manners may reduce the number of sub-regions to some extent, and reduce the complexity and storage requirements of the grid data.

Exemplarily, FIG. 7 is a schematic diagram of another merge operation according to an embodiment of the present disclosure. As shown in the left figure of FIG. 7, a region 71 is a merged sub-region (a dotted line in FIG. 7 represents a common edge, and the region 71 may be a region obtained after triangular regions having a common edge are merged), and the shape of the sub-region is different from that of the first sub-region (that is, a triangle). Furthermore, the region 71 may be re-divided into triangles, and two triangular regions as shown in the right figure of FIG. 7 may be obtained, which are a region 711 and a region 712, respectively, and the region 711 and a region 711 may be taken as third sub-regions.

In the embodiment of the present disclosure, in the case where the plurality of third sub-regions are obtained, vertex data corresponding to the plurality of third sub-regions may be acquired. Further, the vertex data corresponding to the plurality of third sub-regions may be taken as the grid data corresponding to the second image.

It should be noted that one or more second images may be obtained. In the case where one second image is obtained, the grid data corresponding to the second image may be taken as the grid data corresponding to the first image. In the case where a plurality of second images are obtained, a group of grid data may be determined from a plurality of groups of grid data to be taken as the grid data corresponding to the first image. An implementation of the plurality of second images may be described below.

Optionally, performing downsampling processing on the first image to obtain the second image includes: performing downsampling processing on the first image according to a plurality of downsampling parameters to obtain a plurality of second images corresponding to the first image; and determining the grid data corresponding to the first image according to the grid data corresponding to the second image includes: determining the grid data corresponding to the first image from a plurality of groups of grid data according to the number of pixel points and/or the number of sub-regions included in the grid data of the plurality of second images. In this manner, the downsampling images with different resolutions are obtained by downsampling, and the image with an appropriate resolution may be selected for processing in different scenarios, so as to achieve an optimal balance between the rendering effect and the calculation efficiency, and the adaptability to various images and rendering requirements is improved.

The downsampling parameter may be a set of parameters used for controlling the downsampling operation performed on the first image. Optionally, the downsampling parameter includes information such as a sampling rate and a scaling factor. The plurality of downsampling parameters may include a plurality of different sampling rates. Exemplarily, the plurality of sampling rates may range from 8×8 to 64×64.

As an optional implementation of the embodiment of the present disclosure, in a case where the first image is determined, the downsampling processing may be performed on the first image according to the plurality of downsampling parameters, respectively, to obtain a downsampling image corresponding to each downsampling parameter, and the plurality of downsampling images obtained may be taken as the plurality of second images corresponding to the first image. Further, for each second image, the second image is processed by the implementations described in steps S220-S240 to obtain the grid data corresponding to the second image. Further, for the grid data corresponding to each second image, the number of pixel points included in the grid data may be determined. Furthermore, the plurality of numbers of pixel points may be compared with a preset range of the number of pixel points, respectively, to determine at least one group of grid data that satisfies the preset range of the number of pixel points. Further, grid data with a smallest number of pixel points in the at least one group of grid data may be taken as the grid data corresponding to the first image. The preset range of the number of pixel points may be a predetermined range of the number of pixel points that may improve the quality of the rendered image to the maximum extent.

As another optional implementation of the embodiment of the present disclosure, after the grid data corresponding to the plurality of second images is obtained, for each second image, the number of sub-regions included in the grid data corresponding to the second image may be determined. Further, the plurality of numbers of sub-regions may be compared with a preset range of the number of regions, respectively, to determine at least one group of grid data that satisfies the preset range of the number of regions. Further, grid data with a smallest number of sub-regions in the at least one group of grid data may be taken as the grid data corresponding to the first image. The preset range of the number of regions may be a predetermined range of the number of regions that may improve the quality of the rendered image to the maximum extent.

As another optional implementation of the embodiment of the present disclosure, after the grid data corresponding to each second image is obtained, the number of pixel points and the number of sub-regions included in the grid data corresponding to each second image may be determined, respectively. Further, for each second image, the number of pixel points and the number of sub-regions may be processed by a weighted summation operation or an averaging operation to obtain a target index value corresponding to the second image. Further, in a case where the target index values corresponding to the plurality of second images are obtained, grid data corresponding to a largest target index value in the plurality of target index values may be taken as the grid data corresponding to the first image.

Exemplarily, for each second image, a weight value corresponding to the number of pixel points may be determined as a first weight, and a weight value corresponding to the number of sub-regions may be determined as a second weight. Further, the number of pixel points may be multiplied by the first weight to obtain a first indicator value to be processed, and the number of sub-regions may be multiplied by the second weight to obtain a second indicator value to be processed. Further, the first indicator value to be processed and the second indicator value to be processed may be added, and an added indicator value is taken as the target index value corresponding to the second image.

S250, grid data corresponding to the first image is acquired, and the first image is rendered according to the grid data, wherein the grid data is used for indicating a target image region to be rendered in the first image.

In the technical scheme of the embodiment of the present disclosure, before the grid data corresponding to the first image is acquired, the downsampling processing is performed on the first image to obtain the second image, and the binarization processing is performed on the second image to obtain the third image; further, the plurality of region edge points corresponding to the target image region to be rendered in the third image are determined, and the triangulation is performed on the plurality of region edge points to divide the target image region into the plurality of first sub-regions; the grid data corresponding to the second image is determined according to the plurality of first sub-regions, and the grid data corresponding to the first image is determined according to the grid data corresponding to the second image, in this manner, the effect of determining the grid data of the image to be rendered in advance to render the image to be rendered based on the grid data is achieved, in turn, the rendering calculation amount is reduced, the stability of the rendering device is improved, and the rendering efficiency is improved on the premise that the rendering effect is ensured.

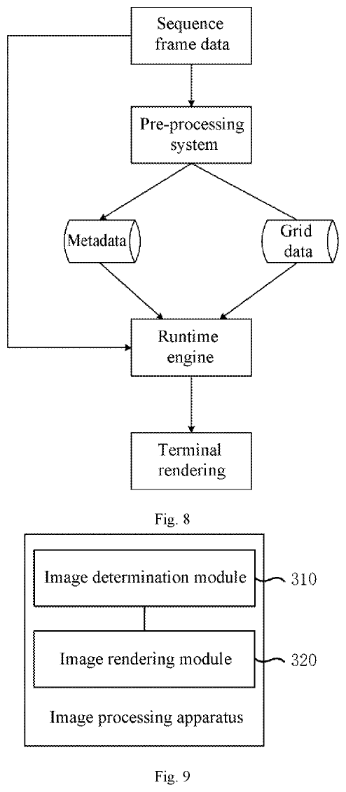

FIG. 8 is a flowchart of an image processing method according to an embodiment of the present disclosure. The embodiment of the present disclosure is a preferred embodiment of the above embodiments of the present disclosure. A plurality of image frames in the sequence frame data may be taken as a first image, and the first image is an image including a transparent background and a foreground object. As shown in FIG. 8, a specific implementation of the embodiment of the present disclosure includes the following steps.

First, the sequence frame data is acquired, and grid data corresponding to the plurality of image frames in the sequence frame data is determined by a pre-processing system to obtain grid data corresponding to the sequence frame data, wherein the pre-processing system may run in a device offline state, and metadata corresponding to the sequence frame data is determined.

The grid data determination process may include the following steps.

The first step: downsampling the first image by using multi-level downsampling to obtain a plurality of downsampling images.

The second step: performing triangulation on each downsampling image by using a Delaunay algorithm to obtain a plurality of triangular regions, wherein a specific process is as follows: first, calculating a bounding box of a first point set composed of a plurality of region edge points, and updating four vertices of the bounding box to the first point set to obtain a second point set; generating two super triangles according to the bounding box to construct an initial triangulation, wherein the initial triangulation may be a Delaunay triangulation; then, inserting vertices in the first point set into the initial triangulation one by one, and adjusting as follows: in the initial triangulation, a union of all triangles whose circumscribed circles contain a first vertex (any vertex in the first point set) constitutes a star-shaped polygon, wherein the star-shaped polygon means that a connection line from any vertex of the polygon to the first vertex is inside the polygon; for the above star-shaped polygon, all triangles inside the star-shaped polygon are deleted to form a “cavity”; and vertices on a boundary of the cavity are connected to the newly added first vertex to obtain new triangles to replace the deleted triangles in the triangulation, at this time, a new Delaunay triangulation containing the first vertex is obtained; and then, when the last vertex is inserted into the triangulation and all edge flipping operations are completed, a Delaunay triangulation of the second point set may be obtained; and further, deleting the four vertices of the bounding box added previously, and removing all triangles connected to the four vertices, then the remaining triangles constitute a Delaunay triangulation of the first point set, that is, a plurality of triangular sub-regions are obtained.

The third step: traversing all triangular regions, scanning whether the sequence frame images have values, and deleting the triangular regions with values.

The fourth step: there may be triangles with a common edge in the remaining triangular regions after deletion, and the triangles with the common edge are merged by reducing the number of faces. Still referring to FIG. 6, since the coordinates of the triangles are aligned with the grid, there are a large number of triangles with a common edge, that is, triangle ABC and triangle CBD may be merged into ABD; further, scanning all edges, if two edges of a pair of triangles on one edge are on a straight line and may be merged into a triangle with a common edge, merging the triangles and generating a new edge, then the triangular region as shown in the right figure of FIG. 6 may be obtained.

The fifth step: for the case where the merged triangular region is a strip-shaped polygonal region, still referring to the left figure in FIG. 7, three triangles may be merged into two triangles CBA and BCE, a pair of twin triangles on one edge may be found, such as ACD and ADC on AD edge; and their common edge may be reorganized into BC edge, that is, reorganized into triangles ACB and BCD; in the strip, BCD and BDE form a triangle with a common edge, which may be optimized by the above method for the triangle with a common edge; if not, checking whether there is a triangle with a common edge on AC edge; and if not, restoring the twin triangles to ACD and ADC.

The sixth step: in a case where a plurality of triangular regions are determined, vertex data of the plurality of triangular regions may be taken as the grid data corresponding to the first image, and the vertex data included in the grid data may be used for rendering the foreground object in the first image.

Further, the sequence frame data, and the grid data and the metadata corresponding to the sequence frame data may be sent to a rendering engine, and the rendering engine runs when the device is in an online state. Further, the sequence frame data may be rendered by the rendering engine according to the grid data and the metadata corresponding to the sequence frame data, so as to render the image region where the foreground object is located in the sequence frame data onto a display interface of a terminal device.

In the technical solution provided by the embodiments of the present disclosure, by combining the multi-level downsampling and contour positioning technology, the blank area may be quickly excluded; by utilizing the spatial and temporal continuity of the sequence frame, the grid data may be shared across frames; by establishing a global vertex identification mapping table, data compression may be realized; moreover, by adopting an off-line-runtime collaborative architecture, a grid sequence format including pre-processed metadata in an off-line pre-processing system is included; and by adopting a strategy in which optimization of common edges takes precedence, the effect of preferentially performing the edge flipping operation on the premise of ensuring topological correctness, ensuring that a convex quadrilateral is generated, and reducing the number of final grid faces is achieved.

FIG. 9 is a schematic diagram illustrating the structure of an image processing apparatus according to an embodiment of the present disclosure. As shown in FIG. 9, the apparatus includes an image determination module 310 and an image rendering module 320. The image determination module 310 is configured to determine a first image in response to an image rendering request, wherein the first image is a single image and/or a plurality of image frames in the sequence frame data; and the image rendering module 320 is configured to acquire grid data corresponding to the first image and render the first image according to the grid data, wherein the grid data is used for indicating a target image region to be rendered in the first image.

In the technical solution of the embodiments of the present disclosure, a first image is determined in response to an image rendering request to provide a data basis for subsequent rendering operations. Since the first image includes a single image and/or a plurality of image frames in the sequence frame data, the single image and/or the plurality of image frames in the sequence frame data are supported as the first image to be rendered, so that the technical solution may be applied to various different scenarios to meet diverse requirements for image rendering. Further, grid data corresponding to the first image is acquired, and the first image is rendered according to the grid data. Since the grid data is used for indicating a target image region to be rendered in the first image, the problem in the related art that rendering computing resources are greatly consumed, resulting in a decline in device performance and low rendering efficiency, is solved. An image corresponding to grid data is rendered based on the grid data capable of indicating an image region to be rendered, thereby achieving the effect of precisely rendering the image to be rendered in regions, reducing the rendering calculation amount, improving the rendering efficiency, and achieving the effect of saving computing resources to the maximum extent on the premise of ensuring the rendering quality of the image region to be rendered in the image, so that a balance between rendering quality and rendering efficiency is achieved.

Based on any optional technical scheme in the embodiments of the present disclosure, the first image includes a plurality of image frames in the sequence frame data; and the grid data corresponding to the plurality of image frames is stored corresponding to the sequence frame data in a form of grid sequence.

Based on any optional technical scheme in the embodiments of the present disclosure, the image rendering module 320 includes a grid data determination unit. The image frame determination unit is configured to determine an image frame to be rendered in the sequence frame data, and determine grid data corresponding to the image frame according to metadata corresponding to the sequence frame data, wherein the metadata is used for indicating a correspondence between the grid data and the image frame.

Based on any optional technical scheme in the embodiments of the present disclosure, the apparatus further includes a downsampling module, a triangulation module, and a network data determination module. The downsampling module is configured to, before the grid data corresponding to the first image is acquired, perform downsampling processing on the first image to obtain a second image, and perform binarization processing on the second image to obtain a third image; the triangulation module is configured to determine a plurality of region edge points corresponding to the target image region to be rendered in the third image, and perform triangulation on the plurality of region edge points to divide the target image region into a plurality of first sub-regions; and the network data determination module is configured to determine grid data corresponding to the second image according to the plurality of first sub-regions, and determine the grid data corresponding to the first image according to the grid data corresponding to the second image.

Based on any optional technical scheme in the embodiments of the present disclosure, the downsampling module includes a downsampling unit. The downsampling unit is configured to perform downsampling processing on the first image according to a plurality of downsampling parameters to obtain a plurality of second images corresponding to the first image. On this basis, the network data determination module includes a grid data determination unit. The grid data determination unit is configured to determine the grid data corresponding to the first image from a plurality of groups of grid data according to the number of pixel points and/or the number of sub-regions included in the grid data of the plurality of second images.

Based on any optional technical scheme in the embodiments of the present disclosure, the downsampling module includes an image binarization unit. The image binarization unit is configured to perform binarization processing on the second image according to a transparency value of a pixel point in the second image; and/or perform binarization processing on the second image according to a color value of at least one color channel of the pixel point in the second image.

Based on any optional technical scheme in the embodiments of the present disclosure, the triangulation module includes an edge point determination unit. The edge point determination unit is configured to perform dilation processing on the target image region to be rendered in the third image, and acquire a plurality of region edge points of the dilated target image region.

Based on any optional technical scheme in the embodiments of the present disclosure, the network data determination module includes a first determination sub-module. The first determination sub-module is configured to determine a second sub-region in the plurality of first sub-regions according to a pixel value of a pixel point in the first sub-regions and a preset numerical value, and determine the grid data corresponding to the second image according to the second sub-region, wherein the preset numerical value is used for indicating the pixel point in the target image region.

Based on any optional technical scheme in the embodiments of the present disclosure, the network data determination module includes a second determination sub-module. The second determination sub-module is configured to perform region reconstruction on the plurality of first sub-regions to obtain a plurality of third sub-regions, and determine the grid data corresponding to the second image according to the third sub-regions, wherein the third sub-regions and the first sub-regions have the same shape, and the number of the third sub-regions is less than the number of the first sub-regions.

Based on any optional technical scheme in the embodiments of the present disclosure, the second determination sub-module includes a sub-region merging unit. The sub-region merging unit is configured to merge a plurality of first sub-regions with a common edge, and determine the plurality of third sub-regions according to a merging result.

Based on any optional technical scheme in the embodiments of the present disclosure, the sub-region merging unit is further configured to merge the plurality of first sub-regions with the common edge into sub-regions with the same shape as the first sub-region to obtain the plurality of third sub-regions; and/or merge the plurality of first sub-regions with the common edge, and re-divide the merged sub-regions into triangles to obtain the plurality of third sub-regions.

Based on any optional technical scheme in the embodiments of the present disclosure, the image rendering module 320 includes a sampling position determination unit and a pixel rendering unit. The sampling position determination unit is configured to, for a pixel point included in the grid data, determine a sampling position of the pixel point in the first image and a display position of the pixel point in a display region; and the pixel rendering unit is configured to sample a color value in the first image according to the sampling position and render the pixel point to the display position corresponding to the pixel point according to the color value.

The image processing apparatus provided by the embodiment of the present disclosure may execute the image processing method provided by any embodiment of the present disclosure, and has corresponding functional modules and beneficial effects for executing the image processing method.

It is worth noting that the units and modules included in the above apparatus are only divided according to functional logic, but are not limited to the above division, as long as the corresponding functions may be realized. In addition, the specific names of the functional units are only for the convenience of distinguishing from each other, and are not used to limit the protection scope of the embodiments of the present disclosure.

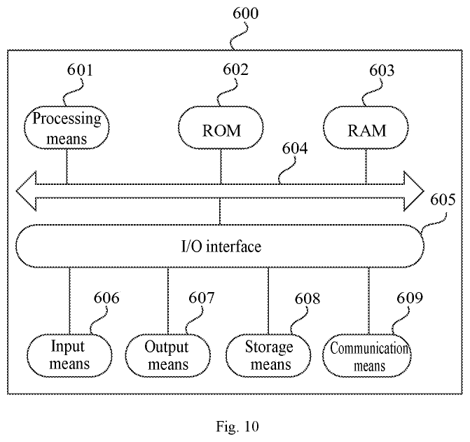

Reference is made to FIG. 10 below, which illustrates a schematic diagram of a structure of an electronic device (such as a terminal device or a server) 600 suitable for implementing an embodiment of the present disclosure. The terminal device in the embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 10 is only an example, and should not impose any limitation on the function and the range of use of the embodiments of the present disclosure.

As shown in FIG. 10, the electronic device 600 may include a processing means 601 (such as a central processing unit and a graphics processor), which may perform various appropriate actions and processing according to a program stored in a read-only memory (ROM) 602 or a program loaded from a storage means 608 into a random access memory (RAM) 603. The RAM 603 further stores various programs and data required for the operation of the electronic device 600. The processing means 601, the ROM 602, and the RAM 603 are connected to each other through a bus 604. An input/output (I/O) interface 605 is also connected to the bus 604.

Usually, the following means may be connected to the I/O interface 605: an input means 606 including, for example, a touch screen, a touchpad, a keyboard, a mouse, a camera, a microphone, an accelerometer, and a gyroscope; an output means 607 including, for example, a liquid crystal display (LCD), a speaker, and a vibrator; the storage means 608 including, for example, a magnetic tape and a hard disk; and a communication means 609. The communication means 609 may allow the electronic device 600 to perform wireless or wired communication with other devices to exchange data. Although FIG. 10 shows the electronic device 600 with various means, it should be understood that it is not required to implement or provide all the means shown. Alternatively, more or fewer means may be implemented or provided.

In particular, according to the embodiments of the present disclosure, the process described above with reference to the flowcharts may be implemented as a computer software program. For example, the embodiments of the present disclosure include a computer program product, which includes a computer program carried on a non-transitory computer-readable medium, wherein the computer program includes program code for performing the method shown in the flowchart. In such an embodiment, the computer program may be downloaded and installed from a network through the communication means 609, or installed from the storage means 608, or installed from the ROM 602. When the computer program is executed by the processing means 601, the above-mentioned functions defined in the method of the embodiment of the present disclosure are executed.

The names of messages or information exchanged between a plurality of means in the implementations of the present disclosure are only for illustrative purposes, and are not intended to limit the scope of these messages or information.

The electronic device provided by the embodiment of the present disclosure belongs to the same inventive concept as the image processing method provided by the above-mentioned embodiment. For technical details not described in detail in the embodiment of the present disclosure, reference may be made to the above-mentioned embodiment, and the present embodiment has the same beneficial effects as the above-mentioned embodiment.

An embodiment of the present disclosure provides a computer storage medium having a computer program stored thereon, wherein the program implements the image processing method provided by the above-mentioned embodiment when executed by a processor.

It should be noted that the above-mentioned computer-readable medium in the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or any combination thereof. More specific examples of the computer-readable storage medium may include, but are not limited to: an electrically connected portable computer magnetic disk with one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that contains or stores a program, and the program may be used by or used in combination with an instruction execution system, apparatus, or device. In the present disclosure, the computer-readable signal medium may include a data signal propagated on a baseband or as a part of a carrier, and computer-readable program code is carried therein. This propagated data signal may take a variety of forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted by any suitable medium, including but not limited to a wire, an optical cable, a radio frequency (RF), or any suitable combination thereof.

According to one or more embodiments of the present disclosure, [Example 1] provides an image processing method, including:

determining a first image in response to an image rendering request, wherein the first image includes a single image and/or a plurality of image frames in the sequence frame data; and

acquiring grid data corresponding to the first image and rendering the first image according to the grid data, wherein the grid data is used for indicating a target image region to be rendered in the first image.

According to one or more embodiments of the present disclosure, [Example 2] provides the method of Example 1, further including: optionally, the first image includes a plurality of image frames in the sequence frame data; and the grid data corresponding to the plurality of image frames is stored corresponding to the sequence frame data.

According to one or more embodiments of the present disclosure, [Example 3] provides the method of Example 2, further including: optionally, the acquiring grid data corresponding to the first image includes: determining an image frame to be rendered in the sequence frame data, and determining grid data corresponding to the image frame according to metadata corresponding to the sequence frame data, wherein the metadata is used for indicating a correspondence between the grid data and the image frame.

According to one or more embodiments of the present disclosure, [Example 4] provides the method of Example 1, further including: optionally, before acquiring the grid data corresponding to the first image, the method further includes: performing downsampling processing on the first image to obtain a second image, and performing binarization processing on the second image to obtain a third image; determining a plurality of region edge points corresponding to the target image region to be rendered in the third image, and performing triangulation on the plurality of region edge points to divide the target image region into a plurality of first sub-regions; and determining grid data corresponding to the second image according to the plurality of first sub-regions, and determining the grid data corresponding to the first image according to the grid data corresponding to the second image.

According to one or more embodiments of the present disclosure, [Example 5] provides the method of Example 4, further including: optionally, the performing downsampling processing on the first image to obtain a second image includes: performing downsampling processing on the first image according to a plurality of downsampling parameters to obtain a plurality of second images corresponding to the first image; and the determining the grid data corresponding to the first image according to the grid data corresponding to the second image includes: determining the grid data corresponding to the first image from a plurality of groups of grid data according to the number of pixel points and/or the number of sub-regions included in the grid data of the plurality of second images.

According to one or more embodiments of the present disclosure, [Example 6] provides the method of Example 4, further including: optionally, the performing binarization processing on the second image includes: performing binarization processing on the second image according to a transparency value of a pixel point in the second image; and/or performing binarization processing on the second image according to a color value of at least one color channel of the pixel point in the second image.

According to one or more embodiments of the present disclosure, [Example 7] provides the method of Example 4, further including: optionally, the determining a plurality of region edge points corresponding to a target image region to be rendered in the third image includes: performing dilation processing on the target image region to be rendered in the third image, and acquiring a plurality of region edge points of the dilated target image region.

According to one or more embodiments of the present disclosure, [Example 8] provides the method of Example 4, further including: optionally, the determining grid data corresponding to the second image according to the plurality of first sub-regions includes: determining a second sub-region in the plurality of first sub-regions according to a pixel value of a pixel point in the first sub-regions and a preset numerical value, and determining the grid data corresponding to the second image according to the second sub-region, wherein the preset numerical value is used for indicating the pixel point in the target image region.

According to one or more embodiments of the present disclosure, [Example 9] provides the method of Example 4, further including: optionally, the determining grid data corresponding to the second image according to the plurality of first sub-regions includes: performing region reconstruction on the plurality of first sub-regions to obtain a plurality of third sub-regions, and determining the grid data corresponding to the second image according to the third sub-regions, wherein the third sub-regions and the first sub-regions have the same shape, and the number of the third sub-regions is less than the number of the first sub-regions.

According to one or more embodiments of the present disclosure, [Example 10] provides the method of Example 8, further including: optionally, the performing region reconstruction on the plurality of first sub-regions to obtain a plurality of third sub-regions includes: merging a plurality of first sub-regions with a common edge, and determining the plurality of third sub-regions according to a merging result.

According to one or more embodiments of the present disclosure, [Example 11] provides the method of Example 10, further including: optionally, the merging the plurality of first sub-regions with the common edge and obtaining the plurality of third sub-regions according to the merging result includes: merging the plurality of first sub-regions with the common edge into sub-regions with the same shape as the first sub-region to obtain the plurality of third sub-regions; and/or merging the plurality of first sub-regions with the common edge, and re-dividing the merged sub-regions into triangles to obtain the plurality of third sub-regions.

According to one or more embodiments of the present disclosure, [Example 12] provides the method of Example 1, further including: optionally, the rendering the first image according to the grid data includes: for a pixel point included in the grid data, determining a sampling position of the pixel point in the first image and a display position of the pixel point in a display region; and sampling a color value in the first image according to the sampling position and rendering the pixel point to the display position corresponding to the pixel point according to the color value.

According to one or more embodiments of the present disclosure, [Example 13] provides an image processing means, including:

an image determination module, configured to determine a first image in response to an image rendering request, wherein the first image includes a single image and/or a plurality of image frames in the sequence frame data; and

an image rendering module, configured to acquire grid data corresponding to the first image and render the first image according to the grid data, wherein the grid data is used for indicating a target image region to be rendered in the first image.

In some implementations, the client and the server may communicate using any currently known or future developed network protocol, such as the hyper text transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The above-mentioned computer-readable medium may be included in the above-mentioned electronic device, or may exist alone without being assembled into the electronic device.

The above-mentioned computer-readable medium carries one or more programs, and when the one or more programs are executed by the electronic device, the electronic device: determines a first image in response to an image rendering request, wherein the first image includes a single image and/or a plurality of image frames in the sequence frame data; and acquires grid data corresponding to the first image and renders the first image according to the grid data, wherein the grid data is used for indicating a target image region to be rendered in the first image.

The computer program code for performing the operations of the present disclosure may be written in one or more programming languages or a combination thereof, wherein the programming languages include, but are not limited to, an object-oriented programming language such as Java, Smalltalk, and C++, and further include conventional procedural programming languages such as “C” language or similar programming languages. The program code may be executed entirely on a user computer, partly on the user computer, as a stand-alone software package, partly on the user computer and partly on a remote computer, or entirely on the remote computer or a server. In the case of involving the remote computer, the remote computer may be connected to the user computer through any kind of network, including a local area network (LAN) or a wide area network (WAN), or may be connected to an external computer (for example, connected through the Internet with the aid of an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, a program segment, or a part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The involved units described in the embodiments of the present disclosure may be implemented in the manner of software, and may also be implemented in the manner of hardware. Here, the name of the unit does not constitute a limitation on the unit itself under certain circumstances, for example, the image determination module may also be described as “a module for determining a first image”.

The functions described above herein may be performed, at least in part, by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only preferred embodiments of the present disclosure and an explanation of the technical principles employed. Those skilled in the art should understand that the disclosed scope involved in the present disclosure is not limited to the technical solutions formed by the specific combination of the above-mentioned technical features, and should also cover, without departing from the above-mentioned disclosed concept, other technical solutions formed by any combination of the above-mentioned technical features or their equivalent features. For example, the above features and the technical features disclosed in the present disclosure (but not limited to) with similar functions are replaced each other to form a technical solution.

In addition, although the operations have been described in a particular order, this should not be understood as requiring the operations to be performed in the particular order shown or in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments may also be implemented in combination in a single embodiment. Conversely, various features described in the context of a single embodiment may also be implemented in a plurality of embodiments individually or in any suitable sub-combination.

Although the subject matter has been described in language specific to structural features and/or method logical actions, it should be understood that the subject matter defined in the appended claims is not necessarily limited to the specific features or actions described above. Conversely, the specific features and actions described above are merely exemplary forms for implementing the claims.

I/We claim:

1. An image processing method, comprising:
determining a first image in response to an image rendering request, wherein the first image comprises a single image and/or a plurality of image frames in sequence frame data; and
acquiring grid data corresponding to the first image and rendering the first image based on the grid data, wherein the grid data is used for indicating a target image region to be rendered in the first image.

2. The image processing method of claim 1, wherein the first image comprises the plurality of image frames in the sequence frame data; and the grid data corresponding to the plurality of image frames is stored corresponding to the sequence frame data.

3. The image processing method of claim 2, wherein acquiring the grid data corresponding to the first image comprises:
determining an image frame to be rendered in the sequence frame data, and determining grid data corresponding to the image frame based on metadata corresponding to the sequence frame data, wherein the metadata is used for indicating a correspondence between the grid data and the image frame.

4. The image processing method of claim 1, wherein before acquiring the grid data corresponding to the first image, the method further comprises:
performing downsampling processing on the first image to obtain a second image, and performing binarization processing on the second image to obtain a third image;
determining a plurality of region edge points corresponding to the target image region to be rendered in the third image, and performing triangulation on the plurality of region edge points to divide the target image region into a plurality of first sub-regions; and
determining grid data corresponding to the second image based on the plurality of first sub-regions, and determining the grid data corresponding to the first image based on the grid data corresponding to the second image.

5. The image processing method of claim 4, wherein performing the downsampling processing on the first image to obtain the second image comprises:
performing downsampling processing on the first image based on a plurality of downsampling parameters to obtain a plurality of second images corresponding to the first image; and
determining the grid data corresponding to the first image based on the grid data corresponding to the second image comprises:
determining the grid data corresponding to the first image from a plurality of groups of grid data based on a number of pixel points and/or a number of sub-regions comprised in the grid data of the plurality of second images.

6. The image processing method of claim 4, wherein performing the binarization processing on the second image comprises:
performing the binarization processing on the second image based on a transparency value of a pixel point in the second image; and/or
performing the binarization processing on the second image based on a color value of at least one color channel of the pixel point in the second image.

7. The image processing method of claim 4, wherein determining the plurality of region edge points corresponding to the target image region to be rendered in the third image comprises:
performing dilation processing on the target image region to be rendered in the third image, and acquiring a plurality of region edge points of the dilated target image region.

8. The image processing method of claim 4, wherein determining the grid data corresponding to the second image based on the plurality of first sub-regions comprises:
determining a second sub-region in the plurality of first sub-regions based on a pixel value of a pixel point in the first sub-regions and a preset numerical value, and determining the grid data corresponding to the second image based on the second sub-region, wherein the preset numerical value is used for indicating a pixel point in the target image region.

9. The image processing method of claim 4, wherein determining the grid data corresponding to the second image based on the plurality of first sub-regions comprises:
performing region reconstruction on the plurality of first sub-regions to obtain a plurality of third sub-regions, and determining the grid data corresponding to the second image based on the third sub-regions, wherein the third sub-regions and the first sub-regions have a same shape, and a number of the third sub-regions is less than a number of the first sub-regions.

10. The image processing method of claim 9, wherein performing the region reconstruction on the plurality of first sub-regions to obtain the plurality of third sub-regions comprises:
merging a plurality of first sub-regions with a common edge, and determining the plurality of third sub-regions based on a merging result.

11. The image processing method of claim 10, wherein merging the plurality of first sub-regions with the common edge and obtaining the plurality of third sub-regions based on the merging result comprises:
merging the plurality of first sub-regions with the common edge into sub-regions with a same shape as the first sub-region to obtain the plurality of third sub-regions; and/or
merging the plurality of first sub-regions with the common edge, and re-dividing the merged sub-regions into triangles to obtain the plurality of third sub-regions.

12. The image processing method of claim 1, wherein rendering the first image based on the grid data comprises:
for a pixel point comprised in the grid data, determining a sampling position of the pixel point in the first image and a display position of the pixel point in a display region; and
sampling a color value in the first image based on the sampling position and rendering the pixel point to the display position corresponding to the pixel point based on the color value.

13. An electronic device, comprising:
one or more processors; and
a storage, configured to store one or more programs,
wherein the one or more programs, when executed by the one or more processors, cause the one or more processors to:
determine a first image in response to an image rendering request, wherein the first image comprises a single image and/or a plurality of image frames in sequence frame data; and
acquire grid data corresponding to the first image and render the first image based on the grid data, wherein the grid data is used for indicating a target image region to be rendered in the first image.

14. The electronic device of claim 13, wherein the first image comprises the plurality of image frames in the sequence frame data; and the grid data corresponding to the plurality of image frames is stored corresponding to the sequence frame data.

15. The electronic device of claim 14, wherein the one or more programs that cause the one or more processors to acquire the grid data corresponding to the first image comprise instructions to cause the one or more processors to:
determine an image frame to be rendered in the sequence frame data, and determine grid data corresponding to the image frame based on metadata corresponding to the sequence frame data, wherein the metadata is used for indicating a correspondence between the grid data and the image frame.

16. The electronic device of claim 13, wherein before acquiring the grid data corresponding to the first image, the one or more processors are further caused to:
perform downsampling processing on the first image to obtain a second image, and perform binarization processing on the second image to obtain a third image;
determine a plurality of region edge points corresponding to the target image region to be rendered in the third image, and perform triangulation on the plurality of region edge points to divide the target image region into a plurality of first sub-regions; and
determine grid data corresponding to the second image based on the plurality of first sub-regions, and determine the grid data corresponding to the first image based on the grid data corresponding to the second image.

17. The electronic device of claim 16, wherein the one or more programs that cause the one or more processors to determine the grid data corresponding to the second image based on the plurality of first sub-regions comprise instructions to cause the one or more processors to:
perform region reconstruction on the plurality of first sub-regions to obtain a plurality of third sub-regions, and determine the grid data corresponding to the second image based on the third sub-regions, wherein the third sub-regions and the first sub-regions have a same shape, and a number of the third sub-regions is less than a number of the first sub-regions.

18. The electronic device of claim 17, wherein the instructions that cause the one or more processors to perform the region reconstruction on the plurality of first sub-regions to obtain the plurality of third sub-regions comprise instructions to cause the one or more processors to:
merge a plurality of first sub-regions with a common edge, and determine the plurality of third sub-regions based on a merging result.

19. The electronic device of claim 13, wherein the one or more programs that cause the one or more processors to render the first image based on the grid data comprise instructions to cause the one or more processors to:
for a pixel point comprised in the grid data, determine a sampling position of the pixel point in the first image and a display position of the pixel point in a display region; and
sample a color value in the first image based on the sampling position and render the pixel point to the display position corresponding to the pixel point based on the color value.

20. A non-transitory storage medium comprising computer-executable instructions, wherein the computer-executable instructions, when executed by a computer processor, cause the computer processor to:
determine a first image in response to an image rendering request, wherein the first image comprises a single image and/or a plurality of image frames in sequence frame data; and
acquire grid data corresponding to the first image and render the first image based on the grid data, wherein the grid data is used for indicating a target image region to be rendered in the first image.
